(19) United States
(12) Patent Application Publication
(10) Pub. No.: US 2007/0017154 A1
(43) Pub. Date: Jan. 25, 2007

(54) Cold chemical water-splitting hydrogen generation system

(76) Inventor: Kuai-Teng Hsu, Clarksville, MD (US)

Correspondence Address: Kuai-Teng Hsu, 7371 Hallmark Road, Clarksville, MD, 21029, US

(21) Appl. No.: 11/188,994

(22) Filed: Jul. 25, 2005

(51) Int. Cl. H01M 8/06; C01B 3/08

(52) U.S. Cl. 48/61; 423/657; 423/658

(57) ABSTRACT

A cold water-splitting hydrogen generation system utilizes Raney Nickel's attribute of dissociating hydrogen from its chemical compound under room temperature (25° C ±) to eliminate heat requirement for the thermochemical water-splitting hydrogen generation process. The thermochemical water-splitting hydrogen generation process uses water as its raw material and iodine and sulfur dioxide as the catalysts. The entire process is promulgated in a single reactor system and thus can easily be adapted for the on-board usages such as automobiles and laptop computers, as well as for large utility power stations.

### BACKGROUND OF INVENTION—FIELD OF INVENTION

This invention relates to a hydrogen and oxygen generation process by splitting the water chemically in a low-temperature environment, so as to provide an economical, safe, environmental friendly, and renewable source of energy.

### DESCRIPTION OF RELATED ARTS—PRIOR ART

Currently, the primary sources of energy are fossil fuels. Due to the global economic and industrial development, fossil fuel resources are depleting at an alarming level and may run out in the near future. In addition, greenhouse gases and other harmful pollutants are emitted when fossil fuels are burned, causing environmental hazards such as global climate change and health risks. It is imperative that alternative energy sources that are safer, cleaner, environmentally friendly, and cost effective are developed.

Hydrogen is the lightest element and has the highest energy content per unit weight of any known fuel. Hydrogen can be combusted either with oxygen directly, producing only water and heat as byproducts, or used in conjunction with oxygen in fuel cells to generate electricity. A big challenge for the production of hydrogen energy is producing enough hydrogen in pure form at an economical cost to compete with the fossil fuels, coal, oil, and natural gas the world now depends on.

Currently, the hydrogen production methods include the following processes:

1. Natural gas and bio-derived liquid reforming process

2. Biomass and hydrocarbon gas separation process

3. Electrolysis water-splitting process

4. Thermolysis water-splitting process

5. Thermochemical water-splitting process

6. Electrochemical water-splitting process

About 95% of the hydrogen used in the United States today is produced by the use of steam to reform methane gas or the gasification of coal in large centralized reformers. Although this process is by far the most economical way of hydrogen production method, it uses fossil fuels as its raw material and requires a massive manufacturing facility. It also requires substantial hydrogen storage, transport and delivery infrastructures. To eliminate the transport and delivery dilemma, small-scale reforming facilities located at the point of use that can produce hydrogen from natural gas or biomass-derived liquid fuels, (i.e. refueling stations and stationary power facilities) are being investigated. In its current form, energy produced by hydrogen through steam reforming of fossil fuel gases is not cost effective when compared with fossil fuel energy production. In addition, the hydrogen produced as such is not pure enough for fuel cell technology. Furthermore, this process of hydrogen production creates unwanted carbon dioxide as a process by-product and thus contributes to the global greenhouse effect.

The biomass and hydrocarbon gas separation process produces hydrogen through the thermochemical conversion of hydrocarbon and biomass-derived gases. Recent advances in biomass hydrogen production by adding catalysts such as Raney Nickel or nickel-aluminum does not make biomass processes a viable major energy source; such a process takes energy to produce and transport fertilizer and to run equipment for growing, harvesting and transporting the crops for biomass. In addition, separating the hydrogen from other gases and purifying the hydrogen diminishes the cost effectiveness of this process.

The electrolysis water-splitting process uses electricity to separate water into its components, hydrogen and oxygen. Currently, two methods of electrolysis water-splitting are used for the commercial production of high purity hydrogen: the alkaline method and the proton exchange membrane (PEM) method. These methods of hydrogen production cannot compete economically with hydrogen produced by natural gas steam reforming.

The thermolysis water-splitting method uses heat to split water into hydrogen and oxygen. The direct thermolysis of water requires temperatures in excess of 2500° C. for significant hydrogen generation. This method of hydrogen production is purely academic and has no commercial value.

The thermochemical water-splitting process dissociates water into hydrogen and oxygen by adding catalysts into the water to promote the chemical reactions and thus significantly reduces the heat requirement for water-splitting process. The two most, highly developed thermochemical processes are the sulfur-iodine and calcium-bromine processes. Both processes contain at least one chemical reaction that requires temperatures in excess of 750° C. For these processes to be commercially viable, heat in excess of 750° C. can only be provided by the next generation of nuclear power plants. In addition, this process requires a massive manufacturing facility and large-scale hydrogen storage, transport and delivery infrastructures. Furthermore, these processes require a complicated and costly gas separation process, which further erodes its cost effectiveness.

The electrochemical water-splitting process combines the electrolysis and the thermochemical processes into one hybrid process. In theory, this process produces twice the amount of the hydrogen than either the electrolysis process or the thermochemical process produces alone. It also reduces the hydrogen generation temperature from 450° C. to 80° C. However, it does not reduce the oxygen generation temperature (850° C.±). For commercial purposes, this temperature requirement can only be provided by the next generation of nuclear power plants. Similar to the thermochemical water-splitting process, electrochemical water process requires a massive manufacturing facility and large-scale hydrogen storage, transport and delivery infrastructures.

As discussed above, it is evident that all current commercial hydrogen generation processes cannot compete economically with fossil fuels. Furthermore, all current commercial hydrogen generation processes require a massive manufacturing facility and large-scale hydrogen storage, transport and delivery infrastructures; thus, they are not suitable for on-board applications such as cars and laptop computers. For hydrogen energy to be a viable alternative to fossil fuel energy the hydrogen production process will have to be greatly simplified and the production equipment vastly downscaled to eliminate the need for hydrogen storage, transport, and delivery.

### BACKGROUND OF INVENTION—OBJECTS AND ADVANTAGES

The main object of the invention is to create a simple hydrogen generation system that uses water as its raw material to produce hydrogen and oxygen that are pure enough to be used with fuel cell technology to produce electricity.

Another object of the invention is to create a hydrogen generation system that uses water as its raw material, a material that is cheap, abundant, renewable, and requires no special process to extract and produce.

Another object of the invention is to create a hydrogen generation system that uses water as its raw material, which can be delivered with the existing infrastructure.

Another object of the invention is to create a hydrogen generation system that uses water as its raw material, a material that is inert, stable and nonflammable.

Another object of the invention is to create a hydrogen generation system that uses water as its raw material and produces no environment harmful byproducts.

Another object of the invention is to create a hydrogen generation system that can provide energy economically for systems as large as a utility power station and as small as laptop computer.

Another object of the invention is to create a hydrogen generation system that requires no special storage, transport and delivery system to its end users.

Another object of the invention is to create a hydrogen generation system that requires minimum external energy inputs to dissociate water into hydrogen and oxygen, thereby minimize the production cost for hydrogen production.

Another object of the invention is to create a hydrogen generation system that requires no external heat to promote the chemical reactions for hydrogen production, so as to reduce the operational hazards.

Another object of the invention is to create a hydrogen generation system, wherein catalysts are added to promote chemical reaction for hydrogen production.

Another object of the invention is to create a hydrogen generation system, wherein catalysts are retained and reused in the chemical reaction chamber, such that the cost of hydrogen production is minimized.

Another object of the invention is to create a hydrogen generation system that requires minimum number of reactants, so as to minimize the hydrogen production cost.

Another object of the invention is to create a hydrogen production system, wherein the number of chemical reaction steps is minimized to maximize the hydrogen production efficiency and economy.

Another object of the invention is to create a hydrogen generation system that requires minimum gas separation measures to minimize hydrogen production cost.

### SUMMARY

In order to accomplish the above objects, the present invention provides an economical hydrogen generation system by:
1. Using water as the raw material for hydrogen generation to eliminate the need of infrastructure for storage and transport of raw materials
2. Using water as the raw material for hydrogen generation to eliminate the environmental harmful byproducts
3. Using proven hydrogen generation catalysts to promote the chemical reactions for hydrogen generation
4. Incorporating the Raney Nickel into the hydrogen generation process to eliminate the need of external heat for the water-splitting chemical reaction
5. Using a single reactor low temperature hydrogen generation system to produce hydrogen economically that is suited for on-board applications.

### DRAWINGS—FIGURES

FIG. 1 is a vertical sectional view of the hydrogen generation reactor according to the preferred embodiment of the present invention.

FIG. 2 is a horizontal sectional view of the hydrogen generation reactor according to the preferred embodiment of the present invention.

### DRAWINGS—REFERENCE NUMERALS

11. Water-splitting reaction tank
12. Raney Nickel Assembly
13. Raney Nickel panel
14. Tank shelf
15. Reactor cap
16. Hydrogen outlet
17. Water supply opening
18. Water-iodine-sulfur dioxide reactants
19. Water level
20. Water-splitting reaction tank top
21. Web plate

### DETAILED DESCRIPTION—PREFERRED EMBODIMENT

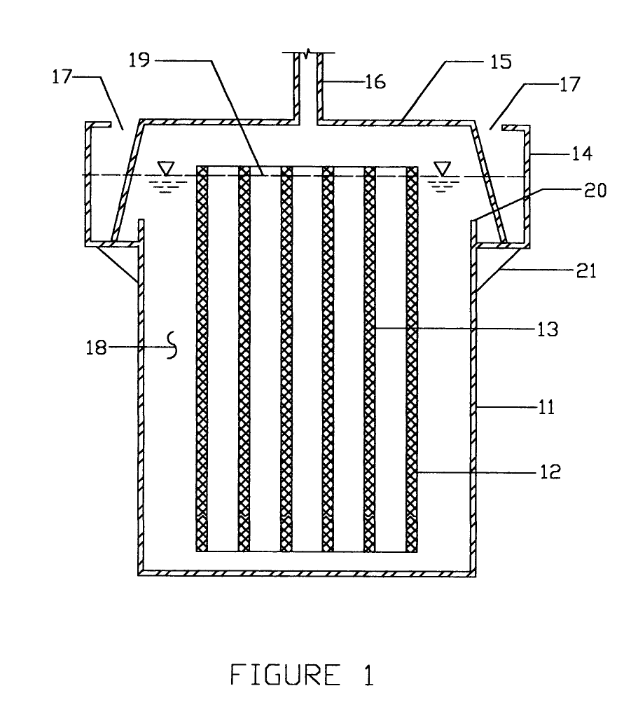

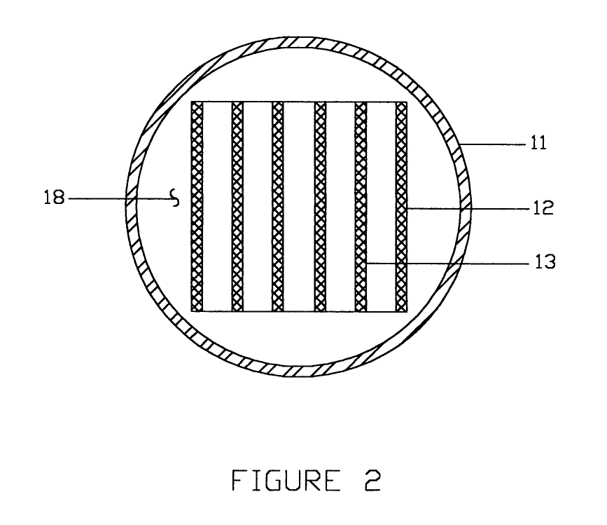

Referring to FIG. 1 and FIG. 2 of drawings, a process of hydrogen generation according to the preferred embodiment of the present invention is illustrated, wherein the hydrogen generation system comprises of a water-splitting reaction tank 11, a Raney Nickel assembly 12, a tank shelf 14, and a reactor cap 15.

The water-splitting reaction tank 11 is made of a round steel tank, wherein the inside face of the tank is coated with porcelain enamel to resist the acidity resulting from the chemical reactions of the water-iodine-sulfur dioxide reactants 18. The capacity of the water-splitting reaction tank 11 is sized according to the hydrogen generation rate requirement for a given application.

The Raney Nickel Assembly 12 is made of a series of Raney Nickel panels 13. The panels are foamy, consisting of alloy of approximate 90 percent nickel and 10 percent aluminum.

The tank shelf 14 is made of steel and is welded to the water-splitting tank 11 at approximately six (6) inches below water-splitting tank top 20. The inside face of the tank shelf 14 is coated with porcelain enamel to resist the acidity resulting from the chemical reactions of the water-iodine-sulfur dioxide reactants 18. The weight of tank shelf 14, the weight of reactor cap 15, and the weight of water above the base of tank shelf 14 are supported by the web plates 21; web plates 21 are welded between the bottom of tank shelf 14 and the wall of water-splitting reaction tank 11.

The reactor cap 15 is made of steel and has hydrogen outlet 16 at its center. The inside face of the reactor cap 15 is coated with porcelain enamel to resist the acidity resulting from the chemical reactions of the water-iodine-sulfur dioxide reactants 18.

The ring shaped water supply opening 17 between tank shelf 14 and reactor cap 15 is provided, where the raw material for hydrogen production, water, can be supplied. The water provided through the water supply opening 17 flows through the small gap between base of tank shelf 14 and base of reactor cap 15. The water level 19 shall be maintained at a level between top of water-splitting reaction tank 20 and a few inches below top of the reactor cap 15.

According to the preferred embodiment of the present invention, in order to enhance the water-splitting process, a predetermined amount of catalysts, iodine (I₂) and sulfur dioxide (SO₂), are provided to form the water-iodine-sulfur dioxide reactants 18. The catalysts will enhance the splitting of the water by reacting with the water (H₂O) to form hydrogen iodide (HI) and sulfuric acid (H₂SO₄). The overall equation of this chemical reaction is as follows:
I₂+SO₂+2H₂O→2HI₍₁₎+H₂SO₄₍₁₎

The ratio between the water used for dissociation, the iodine and sulfur dioxide may vary, but the best ratio is 2:1:1 by mole.

In conventional thermochemical water-splitting processes, the liquid state hydrogen iodide (HI) must be heated to between 200-400° C. to dissociate hydrogen iodide into hydrogen and iodine. The overall chemical reaction of this reaction is as follows:

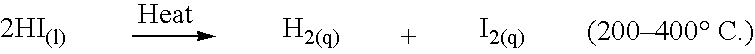

It has been known that Raney Nickel is commonly used as a heat reducing agent to reduce or eliminate the heat requirement in organic syntheses for hydrogen production.

According to the preferred embodiment of the present invention, the Raney Nickel assembly 12 is installed in water-splitting reaction tank 11 as the heat reducing agent to eliminate the heat required to dissociate the hydrogen iodide (HI) into hydrogen gas and iodine. The overall chemical reaction is then as follows:

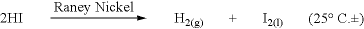

Since the iodine and the sulfur dioxide serve only as the catalysts in the water-splitting process, they are regenerated upon the completion of water-splitting process. The regenerated iodine and sulfur dioxide remain in the water-splitting reaction tank 11 and are to be reused to continue hydrogen generation process.

According to the preferred embodiment of the present invention, the generated hydrogen will bubble up to the free space between reactor cap 15 and water level 19; the hydrogen is then collected through the hydrogen outlet 16. The collected hydrogen can be channeled to on-board fuel cells or other devices for power generation.

Since no heat is used to dissociate hydrogen iodide (HI) into iodine and hydrogen, the iodine remains in water-splitting reaction tank 11 in liquid state, thereby eliminating the need to separate the hydrogen and iodine gas as required in conventional thermochemical water-splitting process.

According to the preferred embodiment of the present invention, many of the raw materials required for the hydrogen generation process, including all the catalysts and a portion of the water, are regenerated and reused for continuous hydrogen generation. The only material that requires refilling is water.

The entire hydrogen generation process requires no heat input. The hydrogen can be generated at room temperature in a single-reactor system.

This hydrogen generation system provides a cheap, abundant and safe fuel system that can be used for automobiles, household electricity generation, and other machines. The reliance on flammable, dangerous, explosive or unclean fuels can be phased out. Furthermore, this process does not emit harmful gases or require dangerous mining, extraction or refinement processes.

### CONCLUSION, RAMIFICATIONS, AND SCOPE OF INVENTION

Thus one skilled in the art will understand that the embodiment of the present invention as shown in the drawings and described above provides an economical way to generate hydrogen below room temperature without emitting environmentally and ecologically harmful byproducts.

Thus it will be seen that the objects of the present invention have been fully and effectively accomplished. Its embodiments have been shown and described for the purposes of illustrating the functional and structural principles of the present invention and are subject to change without departure from such principles. Accordingly, the scope of the invention should be determined not by the embodiment illustrated, but by the appended claims and their legal equivalents.

1. A cold chemical water-splitting hydrogen generation system comprising of:
a water-splitting reaction tank;
a Raney Nickel assembly in said water-splitting reaction tank;
a tank shelf welded to said water-splitting reaction tank;
a reactor cap with a hydrogen outlet at its top;
a water supply opening located between said tank shelf and said reactor cap.

2. The system, as recited in claim 1, wherein the raw material in said water-splitting reaction tank for said hydrogen generation is water.

3. The system, as recited in claim 1, wherein the catalysts for the water-splitting chemical reactions include iodine and sulfur dioxide.

4. The system, as recited in claim 1, wherein said Raney Nickel assembly is made of Raney Nickel panels and is installed in said water-splitting reaction tank to serve as a heat reducing agent, thus eliminating the heat requirement for said water-splitting process.

5. The system, as recited in claims 2 and 3, wherein the ratio between said water, said iodine, and said sulfur dioxide is 2:1:1 by mole.

6. The system, as recited in claims 2 and 3, wherein said iodine, said sulfur dioxide and a portion of said water to be split are regenerated, retained, and reused in said water-splitting reaction tank for the continuance of said hydrogen generation process.

7. The system, as recited in claim 1, is a single reactor system and requires no recycling of said iodine and said sulfur dioxide as the catalysts for the continuance of said hydrogen generation process.

8. The system, as recited in claim 1, is a single reactor system and has the said hydrogen outlet at its top to collect said hydrogen.

9. The system, as recited in claim 1, is a single reactor system and requires no gas separation devices.

10. The system, as recited in claim 1, wherein the said reactor cap is located at the top of said water-splitting reaction tank and is loosely connected to said tank shelf to facilitate the replacement of the said Raney Nickel Panel.
